(19) United States
(12) Patent Application Publication
(10) Pub. No.: US 2014/0022820 A1
(43) Pub. Date: Jan. 23, 2014

(54) RING-SHAPED LIGHT GUIDING MEMBER AND BACKLIGHT MODULE HAVING SAME

(71) Applicant: HON HAI PRECISION INDUSTRY CO., LTD., New Taipei (TW)

(72) Inventor: LI-YING WANG HE, New Taipei (TW)

(73) Assignee: HON HAI PRECISION INDUSTRY CO., LTD., New Taipei (TW)

(21) Appl. No.: 13/686,958

(22) Filed: Nov. 28, 2012

(30) Foreign Application Priority Data
Jul. 17, 2012 (TW) 101125696

(51) Int. Cl. G02B 6/26; G09F 13/18

(52) U.S. Cl. CPC G02B 6/26; G09F 13/18
USPC 362/611; 385/31

(57) ABSTRACT

A ring-shaped light guiding member includes a ring-shaped light guiding main body having a circumferential surface, and a light introducing portion formed on the circumferential surface. The light introducing portion includes a flat light incident surface perpendicularly connected to the circumferential surface and a curved side surface connected between the light incident surface and the circumferential surface. A backlight module using the ring-shaped light guiding member is also provided.

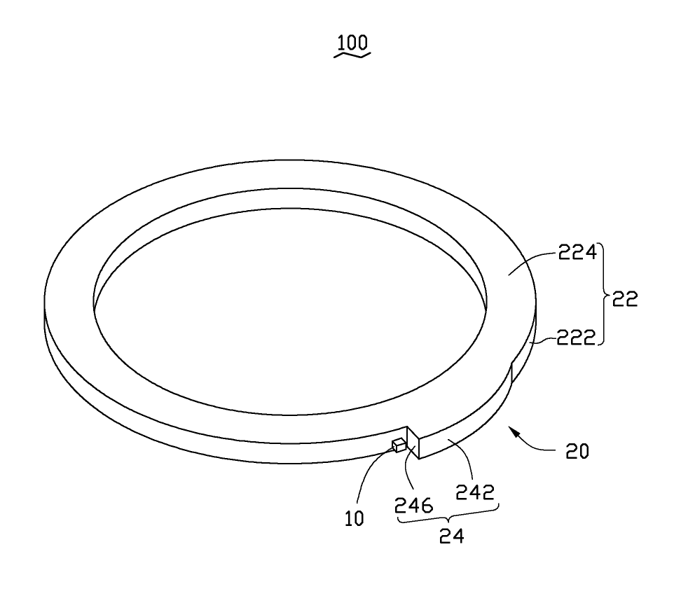

### BACKGROUND

1. Technical Field

The present disclosure relates to light guiding members, and particularly to a ring-shaped light guiding member and a backlight module having the light guiding member.

2. Description of Related Art

Ring-shaped light guiding members can be used in backlight modules for instruments and displays. However, light does not diffuse well in the ring-shaped configuration creating a dark area in the light guiding member.

What is needed, therefore, is a ring-shaped light guiding member and a backlight module having same, which can overcome the above shortcomings.

### BRIEF DESCRIPTION OF THE DRAWINGS

Many aspects of the present ring-shaped light guiding member and backlight module can be better understood with reference to the following drawings. The components in the drawings are not necessarily drawn to scale, the emphasis instead being placed upon clearly illustrating the principles of the present ring-shaped light guiding member and backlight module. Moreover, in the drawings, like reference numerals designate corresponding parts throughout the several views.

The FIGURE is a schematic isometric view a backlight module in accordance with a first embodiment.

### DETAILED DESCRIPTION

Embodiments of the present ring-shaped light guiding member and backlight module will now be described in detail below and with reference to the drawing.

Referring to the figure, a backlight module 100 in accordance with an embodiment is provided. The backlight module 100 includes a light source 10 and a ring-shaped member 20.

The light source 10 may be one or a number of lighting tubes or LEDs. The ring-shaped light guiding member 20 includes a ring-shaped light guiding main body 22 and a light introducing portion 24 integrally formed with the main body 22. The light introducing portion 24 extends from a circumferential surface 222 of the main body 22 and covers the main body 22.

The light introducing portion 24 includes a flat light incident surface 246 perpendicularly connected to the circumferential surface 222 and a curved side surface 242 connected between the light incident surface 246 and the circumferential surface 222. In the present embodiment, the main body 22 is circular ring-shaped, i.e., the circumferential surface 222 is arc-shaped, and the light incident surface 246 is rectangular in shape.

A thickness of the light introducing portion 24 relative to the circumferential surface 222 gradually increases as closer to the light incident surface 246. The main body 22 and the light introducing portion 24 have a same height relative to a horizontal surface.

The light source 10 is arranged adjacent to the light incident surface 246, and is aimed at the light incident surface 246. This arrangement controls light to travel through the light introducing portion 24 to the main body 22, and diffuse evenly through the entire main body 22. That is, the light introducing portion 24 helps more light incident the main body 22, and the circular ring-shaped configuration of the main body 22 which does not have a turning also helps light travel through the entire main body 22.

The main body 22 has a top surface 224 perpendicular to the light incident surface 246 for emitting light.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A ring-shaped light guiding member, comprising:
a ring-shaped light guiding main body having a circumferential surface; and
a light introducing portion formed on the circumferential surface, the light introducing portion comprising a flat light incident surface perpendicularly connected to the circumferential surface and a curved side surface connected between the light incident surface and the circumferential surface.

2. The ring-shaped light guiding member of claim 1, wherein a thickness of the light introducing portion relative to the circumferential surface gradually increases as closer to the light incident surface.

3. The ring-shaped light guiding member of claim 1, wherein the light incident surface is rectangular.

4. The ring-shaped light guiding member of claim 1, wherein the circumferential surface is arc-shaped.

5. The ring-shaped light guiding member of claim 1, wherein the light guiding main body includes a top surface perpendicular to the light incident surface for emitting light.

6. A backlight module, comprising:
a ring-shaped light guiding member, comprising:
a ring-shaped light guiding main body having a circumferential surface; and
a light introducing portion formed on the circumferential surface, the light introducing portion comprising a flat light incident surface perpendicularly connected to the circumferential surface and a curved side surface connected between the light incident surface and the circumferential surface; and
a light source arranged adjacent to the light incident surface of the ring-shaped light guiding member.

7. The backlight module of claim 6, wherein a thickness of the light introducing portion relative to the circumferential surface gradually increases as closer to the light incident surface.

8. The backlight module of claim 6, wherein the light incident surface is rectangular.

9. The backlight module of claim 6, wherein the circumferential surface is arc-shaped.

10. The backlight module of claim 6, wherein the light guiding main body includes a top surface perpendicular to the light incident surface for emitting light.

11. The backlight module of claim 6, wherein the light guiding main body and the light introducing portion have a same height relative to a horizontal surface.
